(19) United States
(12) Patent Application Publication
(10) Pub. No.: US 2020/0233141 A1
(43) Pub. Date: Jul. 23, 2020

(54) LIGHT SOURCE MODULE AND DISPLAY DEVICE

(71) Applicant: Coretronic Corporation, Hsin-Chu (TW)

(72) Inventors: WEN-HSUN YANG, Hsin-Chu (TW); YUNG-I TSAI, Hsin-Chu (TW); FU-MING CHUANG, Hsin-Chu (TW)

(21) Appl. No.: 16/742,928

(22) Filed: Jan. 15, 2020

(30) Foreign Application Priority Data
Jan. 18, 2019 (CN) 201910047378.X

(51) Int. Cl. F21V 8/00

(52) U.S. Cl. CPC G02B 6/0036; G02B 6/0055; G02B 6/0051; G02B 6/005

(57) ABSTRACT

A display device includes a light source module and a display panel that is disposed relative to the light source module. The light source module includes a substrate, a plurality of light emitting dies, an encapsulation layer, and a plurality of reflection patterns. The substrate has a bearing surface, the light emitting dies are disposed on the bearing surface of the substrate. The encapsulation layer covers the bearing surface and the plurality of light emitting dies. The encapsulation layer includes a light emitting surface away from the bearing surface, a bottom surface connected to the bearing surface and at least one light guide side surface. The at least one light guide side surface connected to the light emitting surface, and is inclined with respect to the light emitting surface. The plurality of reflection patterns is respectively disposed in the plurality of reflecting recesses.

### CROSS-REFERENCE TO RELATED APPLICATION

This application claims the priority benefit of China application 201910047378.X, filed on 2019, Jan. 18. The entirety of the above-mentioned patent application is hereby incorporated by reference herein and made a part of this specification.

### FIELD OF THE INVENTION

The invention relates to a light source module and a display device, and more particularly to a direct type light source module and a display device having the direct type light source module.

### BACKGROUND OF THE INVENTION

The liquid crystal display mainly includes components such as a backlight module, a display panel, and an outer frame. According to the light emission direction of the light source of the backlight module, the backlight module can be further divided into a side-edge backlight module and a direct type backlight module. Currently, available medium-sized or large-sized liquid crystal display using a light emitting diode (LED) as a light source of the backlight module use a direct type backlight module with local dimming function for high dynamic range (HDR) and high contrast requirements. The characteristic of the light emitting diode is that it has strong normal light. Therefore, the structure of the direct type backlight module is to convert the light of the light emitting diode into a uniform surface light source and then emits to the display panel.

The backlight module of the liquid crystal display has a backlight chamber. A plurality of light emitting diodes may be located at the bottom of the backlight chamber, and a diffuser plate may be disposed above the backlight chamber. When the thickness of the backlight chamber is sufficient, the light of the light emitting diodes can be sufficiently diffused in the backlight chamber to obtain a uniform surface light source. If the thickness of the backlight chamber is reduced in order to reduce the thickness of the overall backlight module, more light emitting diodes should disposed at the bottom of the backlight chamber to reduce the spacing between the light emitting diodes and improve the uniformity of the surface light source, but also cause an increase in cost.

In addition to arranging more light emitting diodes in the backlight chamber, another way to reduce the thickness of the backlight chamber and to maintain or even evenly spread the light is to diffuse the light from the light emitting diodes in the backlight chamber. However, since the light emitting diode has a strong normal light, even if the divergence angle of the light of the light emitting diode is diffused by the optical lens, a bright spot is found above the light emitting diode during the actual performance. In addition, the light emitting diodes have a limited diffusion distance in the backlight chamber, thus limiting the thickness of the backlight chamber that can be reduced.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a light source module, which can provide a uniform surface light source while effectively reducing the backlight thickness.

The invention provides a display device having a light source module of a lower thickness and capable of providing a uniform surface light source.

Other advantages and objects of the invention may be further illustrated by the technical features broadly embodied and described as follows.

In order to achieve one or a portion of or all of the objects or other objects, a light source module provided in an embodiment of the invention includes a substrate, a plurality of light emitting dies, an encapsulation layer, and a plurality of reflection patterns. The substrate has a bearing surface, the plurality of light emitting dies is disposed on the bearing surface of the substrate, and the encapsulation layer covers the bearing surface and the plurality of light emitting dies. Encapsulation layer includes a light emitting surface away from the bearing surface, a bottom surface connected to the bearing surface and at least one light guide side surface. An area of the light emitting surface is smaller than an area of the bottom surface, the light emitting surface has a plurality of reflecting recesses respectively disposed corresponding to the plurality of light emitting dies. The plurality of reflecting recesses respectively include a surrounding side surface inclined with respect to the light emitting surface. The at least one light guide side surface connected to the light emitting surface, and inclined with respect to the light emitting surface. The plurality of reflection patterns is respectively disposed in the plurality of reflecting recesses.

In order to achieve one or a portion of or all of the objects or other objects, a display device provided in an embodiment of the invention includes a plurality of light source modules arranged at an interval from each other and a display panel disposed opposite to the light source modules.

In the light source module and the display device of the embodiment of the invention, the light emitting surface of the encapsulation layer has a plurality of reflecting recesses and a plurality of reflection patterns respectively disposed in the plurality of reflecting recesses. A light having a smaller angle (the light with a small angle between the light and the normal of the bearing surface) emitted by the plurality of light emitting dies disposed opposite to the reflecting recesses can be reflected by the reflection patterns in the reflecting recesses to avoid the problem that a bright spot can still be detected above the light emitting die even if an optical lens is disposed on the light emitting die as in the prior art.

The encapsulation layer of the light source module of the embodiment of the invention has a light guiding side surface, and a light can be transmitted through the light guiding side surface away from the bearing surface and a center of the light source module, thereby avoiding bright lines or dark lines caused by intervals between adjacent light source modules, so that the display device of the embodiment of the invention has good uniformity.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a light source module of one embodiment of the invention;

FIG. 2A is a schematic partial enlarged cross-sectional view of a light source module of one embodiment of the invention;

FIG. 2B is a schematic partial enlarged cross-sectional view of a light source module of one embodiment of the invention;

FIG. 3 is a simulation comparison diagram of the light emitting effects of a light source module of the invention and a light source module of the prior art;

FIG. 4 is a schematic partial enlarged cross-sectional view of a light source module of one embodiment of the invention;

FIG. 5 is a schematic partial enlarged cross-sectional view of a light source module of one embodiment of the invention;

FIG. 6 is a schematic partial enlarged cross-sectional view of a light source module of one embodiment of the invention;

FIG. 7 is a schematic partial enlarged cross-sectional view of a light source module of one embodiment of the invention;

FIG. 8 is a schematic cross-sectional view of a display device of one embodiment of the invention;

FIG. 9A is a schematic top view of a light source module of another embodiment of the invention;

FIG. 9B is a schematic cross-sectional view along a line AA of FIG. 9A;

FIG. 10 is a schematic cross-sectional view of a light source module of another embodiment of the invention;

FIG. 11A to FIG. 11C are respectively schematic cross-sectional views of another embodiments of light source modules of the invention;

FIG. 12A is a schematic top view of splicing of a plurality of light source modules of a display device of another embodiment of the invention;

FIG. 12B is a schematic cross-sectional view along a line BB of FIG. 12A; and

FIG. 13 is a schematic view of splicing of a plurality of light source modules of a display device of another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

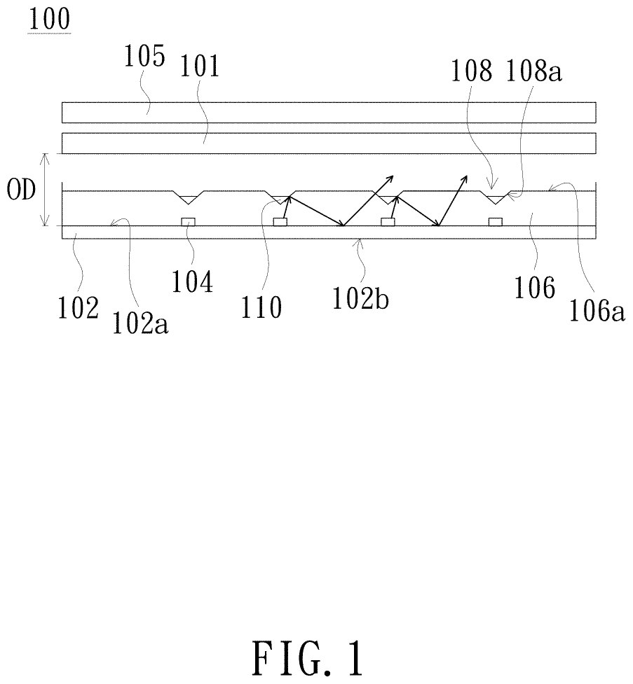

FIG. 1 is a schematic cross-sectional view of a light source module of one embodiment of the invention. Referring to FIG. 1, a light source module 100 of the embodiment includes a substrate 102, a plurality of light emitting dies 104, an encapsulation layer 106, and a plurality of reflection patterns 110. The substrate 102 has a bearing surface 102a and a base surface 102b, and the plurality of light emitting dies 104 is disposed on the bearing surface 102a of the substrate 102. The encapsulation layer 106 covers the bearing surface 102a and the plurality of light emitting dies 104. The encapsulation layer 106 has a light emitting surface 106a away from the bearing surface 102a, and the light emitting surface 106a has a plurality of reflecting recesses 108 respectively disposed corresponding to the plurality of light emitting dies 104. The plurality of reflecting recesses 108 respectively includes a surrounding side surface 108a inclined with respect to the light emitting surface 106a. The plurality of reflection patterns 110 is respectively disposed in the plurality of reflecting recesses 108 to reflect the lights having a smaller angle with the normal of the bearing surface 102a emitted by the plurality of light emitting dies 104.

In the embodiment, the substrate 102 can be a circuit board, and the bearing surface 102a can be a reflective surface and a plurality of conductive patterns (not shown) are disposed in a portion area of the bearing surface 102a to electrically connect the plurality of light emitting dies 104. The bearing surface 102a is provided with a white lacquer reflective sheet or coating having diffuse reflection properties or a silver lacquer reflective sheet or coating having specular reflection properties, to dispose the bearing surface 102a as a reflective surface. In one embodiment, the substrate 102 may include a transparent plate having the bearing surface 102a and a bottom reflective layer (not shown) disposed on the base surface 102b of the transparent plate opposite to the bearing surface 102a, and similarly a plurality of conductive patterns is disposed in a portion area of the bearing surface 102a to electrically connect the plurality of light emitting dies 104. The material of the transparent plate may include glass or plasticized material, and the bottom reflective layer may be provided with a white lacquer reflective sheet or coating having diffuse reflection properties, or a silver lacquer reflective sheet or coating having specular reflection properties.

In the embodiment, the light emitting die 104 can be a die that is cut directly from an epitaxy wafer and not encapsulated. The light emitting die 104 may be a light emitting diode die, specifically, for example, a grain size level nitride light emitting diode die that emits light having a dominant wavelength in blue light range. The plurality of light emitting dies 104 may be arranged in an array on the bearing surface 102a. The light source module 100 of the embodiment may be a direct type light source module, and the main light emitting surface of each of the light emitting dies 104 faces the light emitting surface 106a and is away from the bearing surface 102a.

In the embodiment, the material of the encapsulation layer 106 may be a silicone encapsulation resin having a refractive index of 1.41, but the material of the encapsulation layer 106 may also be an epoxy resin, UV curable resin or other encapsulation material that can be used to encapsulate the light emitting dies 104. The light emitting surface 106a of the encapsulation layer 106 may be provided with a plurality of recesses and/or a plurality of protrusions (not shown) or roughened by, for example, sand blasting or etching (not shown) in a region where the plurality of reflecting recesses 108 is not disposed, so that the light emitted from the light emitting die 104 can be more uniformly diffused when emitted from the light emitting surface 106a.

In the embodiment, the light source module 100 may further include a diffusion plate 101. The diffusion plate 101 is disposed above the encapsulation layer 106 at an interval, and the distance between the diffusion plate 101 and the bearing surface 102a can be defined as an optical distance OD. A wavelength conversion film 105 may be disposed on the diffusion plate 101 or between the diffusion plate 101 and the encapsulation layer 106, so that the diffusion plate 101 and the wavelength conversion film 105 may be included in an optical structure in a laminated structure. In another embodiment, an optical plate may contain diffusion particles and wavelength conversion particles to have functions of light diffusion and wavelength conversion. The wavelength conversion film 105 may include a wavelength conversion material such as a quantum dot or a phosphor to convert the wavelength of a part of the light emitted by the light emitting dies 104. For example, when the light emitting die 104 is a light emitting diode die that emits light having a dominant wavelength in blue light range, after the wavelength conversion film 105 is excited by a part of the blue light, the part of the blue light can be converted into a yellow light and mixed with the other part of the blue light to form a white light. However, the wavelength conversion film 105 can also contain different wavelength conversion materials as needed to convert the light emitted by the light emitting dies 104 into one or more colors. The optical structure may further include other optical films such as a brightness enhancement film.

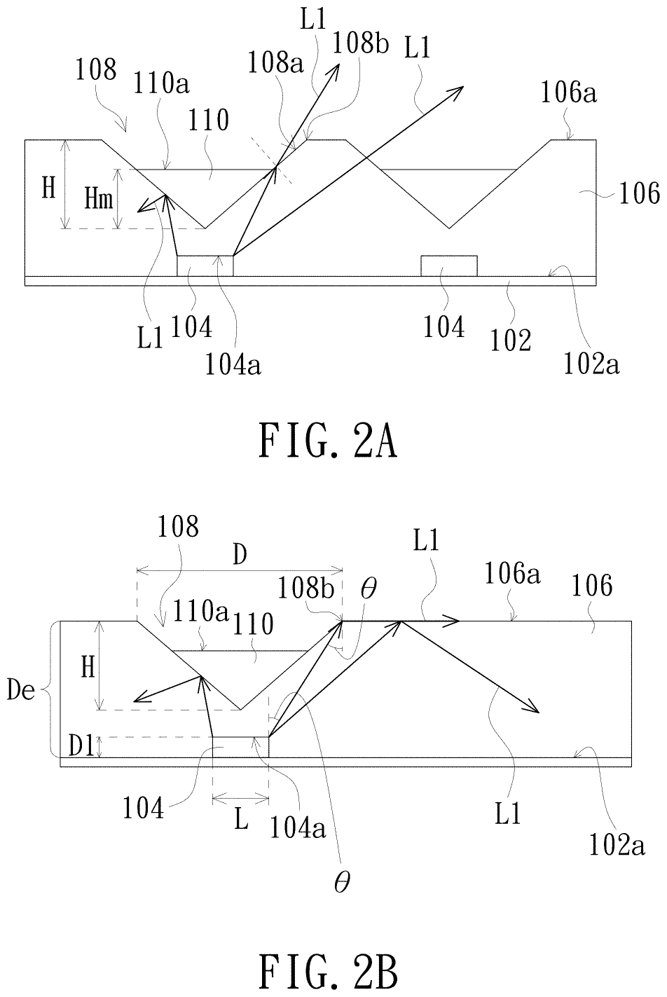

FIG. 2A is a schematic partial enlarged cross-sectional view of a light source module of one embodiment of the invention. Referring to FIG. 2A, the reflection pattern 110 covers the bottom of the reflecting recess 108 and does not fill up the reflecting recess 108. The distance between a top surface 110a of the reflection pattern 110 away from a bottom of the reflecting recess 108 and the bottom of the reflecting recess 108, that is, the thickness Hm of the reflection pattern 110, is smaller than the depth H of the reflecting recess 108. Preferably, the ratio Hm/H of the thickness Hm of the reflection pattern 110 to the depth H of the reflecting recess 108 may be between 0.6 and 0.8. In this embodiment, the reflecting recess 108 has an opening 108b on the light emitting surface 106a, and the light emitting die 104 disposed on the bearing surface 102a of the substrate 102 includes a light emitting surface 104a facing the opening 108b. An area of the opening 108b is larger than an area of the light emitting surface 104a. Portion of the light L1 emitted by the light emitting die 104 toward the reflecting recess 108 is reflected on the surrounding side surface 108a covered with the reflection pattern 110, and portion of the light L1 has a chance to be refracted above the reflection pattern 110 at the surrounding side surface 108a not covered by the reflection pattern 110. In the embodiment, the reflection pattern 110 may contain a single layer of reflective layer. The material of the reflective layer may be white lacquer having diffuse reflection properties, or a silver lacquer having specular reflection properties. In the embodiment, the bottom of the reflecting recess 108 is a tip that tapers from the surrounding side surface 108a and is disposed substantially opposite to a center of the light emitting die 104. The surrounding side surface 108a is an inclined plane having a single slope, so that a cross-sectional shape of the reflecting recess 108 is close to an isosceles triangle in a cross-sectional view through the center of the corresponding pair of the light emitting die 104 and a center of the reflecting recess 108 and perpendicular to the light emitting surface 106a. However, the surrounding side surface 108a may also have a plurality of inclined planes of different slopes or a concave surface or convex surface of different curvatures, or the surrounding side surface 108a can be disposed as a step, so that the cross-sectional shape of the reflecting recess 108 includes a hemispherical, a semi-ellipsoidal, a parabolic or a polygonal.

FIG. 2B is a schematic partial enlarged cross-sectional view of a light source module of one embodiment of the invention. Referring to FIG. 2B, in the embodiment, in the cross-sectional view through the center of the corresponding pair of the light emitting die 104 and the center of the reflecting recess 108 and perpendicular to the light emitting surface 106a, a distance between two ends of the opening 108b is D, a distance between two ends of the light emitting surface 104a is L, a distance between the light emitting surface 104a and the bearing surface 102a, i.e. the thickness of the light emitting die 104 is Dl, a distance between the bearing surface 102a and the light emitting surface 106a is De, a depth of the reflecting recess 108 is H, and H<De-Dl, a refractive index of the encapsulation layer 106 is Nm, and a refractive index of air is Na, a total reflection critical angle of a light beam L1 emitted from one end of the light emitting surface 104a toward the light emitting surface 106a is θ, and θ=sin⁻¹ (Na/Nm), the distance D between the two ends of the opening 108b (i.e., the width of the opening 108b) satisfies a relationship: D≥2×[(De-Dl)×tan(sin⁻¹ (Na/Nm))+L/2]. Thereby, the light L1 that is directly incident on the light emitting surface 106a other than the opening 108b of the reflection recess 108 by the light emitting die 104 is totally reflected.

In the light source module 100 of the embodiment, since the light emitting surface 106a of the encapsulation layer 106 has a plurality of reflecting recesses 108 and a plurality of reflection patterns 110 respectively disposed in the plurality of reflecting recesses 108, the light L1 having a smaller angle (the light L1 with a small angle between the light and the normal of the bearing surface 102a) emitted by the plurality of light emitting dies 104 disposed relative to the reflecting recess 108 can be reflected by the reflection pattern 110, so as to avoid the problem in the prior art in which the bright spot is still detected above the light emitting die even the optical lens is disposed on the light emitting die.

The width D of the opening 108b of each of the plurality of reflecting recesses 108 of the encapsulation layer 106 of the light source module 100 of the embodiment satisfies the above relationship: D≥2×[(De-Dl)×tan(sin⁻¹ (Na/Nm))+L/2], so that the light L1 that is directly incident on the light emitting surface 106a other than the opening 108b of the reflection recess 108 by the light emitting die 104 is totally reflected back into the encapsulation layer 106, and is sufficiently diffused toward the entire light emitting surface 106a by multiple total reflections in the encapsulation layer 106. Therefore, the optical distance OD can be reduced without increasing the quantity of configuration of the light emitting dies 104, and overcome the problem in the prior art in which the diffusion distance of the light of the light emitting die in the backlight chamber is limited.

In the embodiment, the reflection pattern 110 of the light source module 100 does not completely fill the reflecting recess 108. Since the material refractive index of the encapsulation layer 106 is greater than the refractive index of the air, portion of the light L1 of the light emitting die 104 may be refracted above the reflection pattern 110 by the surrounding side surface 108a that is not covered by the reflection pattern 110, and the light provided by the other light emitting dies 104 is also applied above the reflection pattern 110 to compensate the dark area above the reflection pattern 110.

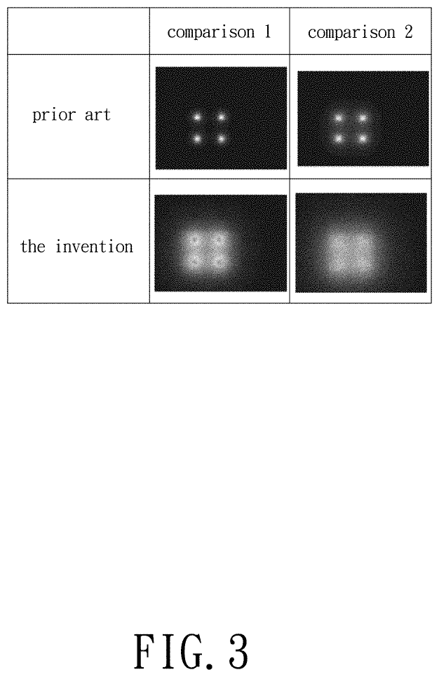

FIG. 3 is a simulation comparison diagram of the light emitting effects of a light source module of the invention and a light source module of the prior art, through which the benefits of the invention is further verified. Referring to FIG. 3, this simulation comparison diagram is obtained by comparing the light source module of the embodiment of FIG. 2A disclosed in the invention with the known light source module in which the light emitting dies are covered by only the encapsulation layer without reflecting recesses. Both use four forward emitting light emitting dies disposed on the surface of a white circuit board with diffuse reflection properties, and a silicone encapsulating resin having a refractive index of 1.41 and a thickness of 1 mm as an encapsulation layer. The column of the Comparison 1 in FIG. 3 shows the light emitting effect above the encapsulation layer. As shown, it is apparent that bright spots of the four light emitting dies of the light source module of the invention are more blurred than that in the prior art. The column of the Comparison 2 in FIG. 3 shows the light emitting effect above the encapsulation layer on which a diffusion plate and two brightness enhancement films are disposed. As shown, the bright spots of the four light emitting dies of the prior art can still be clearly distinguished, but the bright spots of the four light emitting dies of the invention are further blurred.

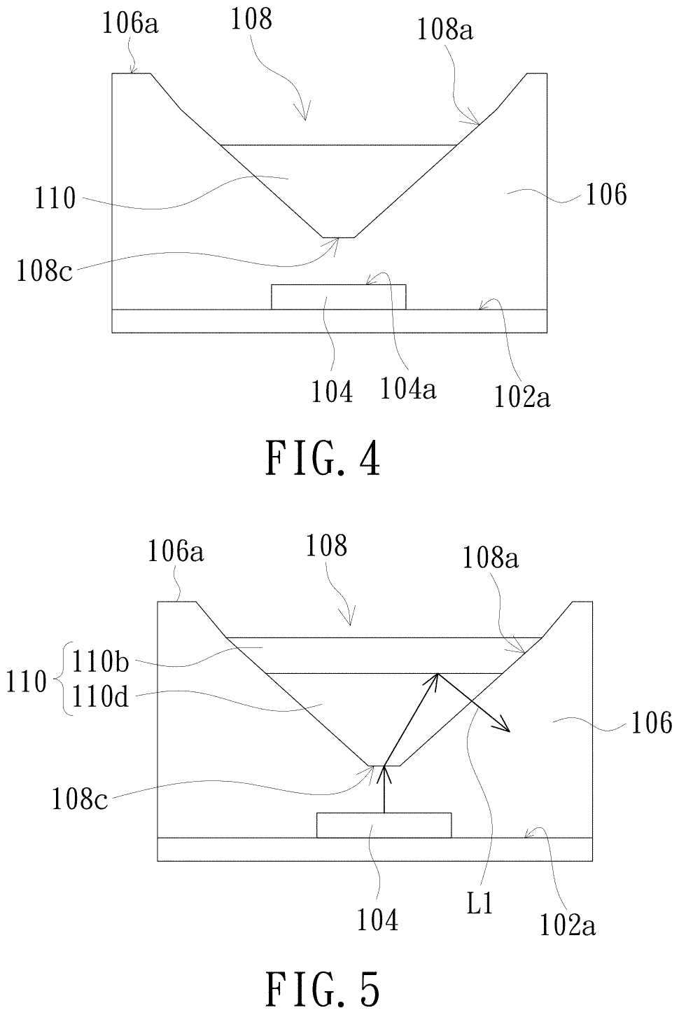

FIG. 4 is a schematic partial enlarged cross-sectional view of a light source module of one embodiment of the invention. Referring to FIG. 4, in the embodiment, the reflecting recess 108 includes a bottom surface 108c, and the bottom of the surrounding side surface 108a is connected to an edge of the bottom surface 108c. The bottom surface 108c can include a curved surface or a plane parallel to the bearing surface 102a. In the cross-sectional view passing through a center of a pair of corresponding light emitting dies 104 and the center of the reflecting recess 108 and perpendicular to the light emitting surface 106a, the projection of the bottom surface 108c along a normal direction of the bearing surface 102a on the light emitting surface 104a of the light emitting die 104 may cover a center of the light emitting die 104. Thus, in the process of forming the reflective recesses 108 of the encapsulation layer 106, the plurality of reflecting recesses 108 can be respectively disposed on the plurality of light emitting dies 104 within an allowable error range, thereby reducing the difficulty to align the reflecting recesses 108 to the light emitting dies 104. In the embodiment, in the cross-sectional view passing through the center of a pair of corresponding light emitting dies 104 and the center of the reflecting recess 108 and perpendicular to the light emitting surface 106a, the reflecting recess 108 may have a sectional shape close to a trapezoid. The embodiment is substantially the same as the above embodiment except that the reflecting recess 108 has the bottom surface 108c.

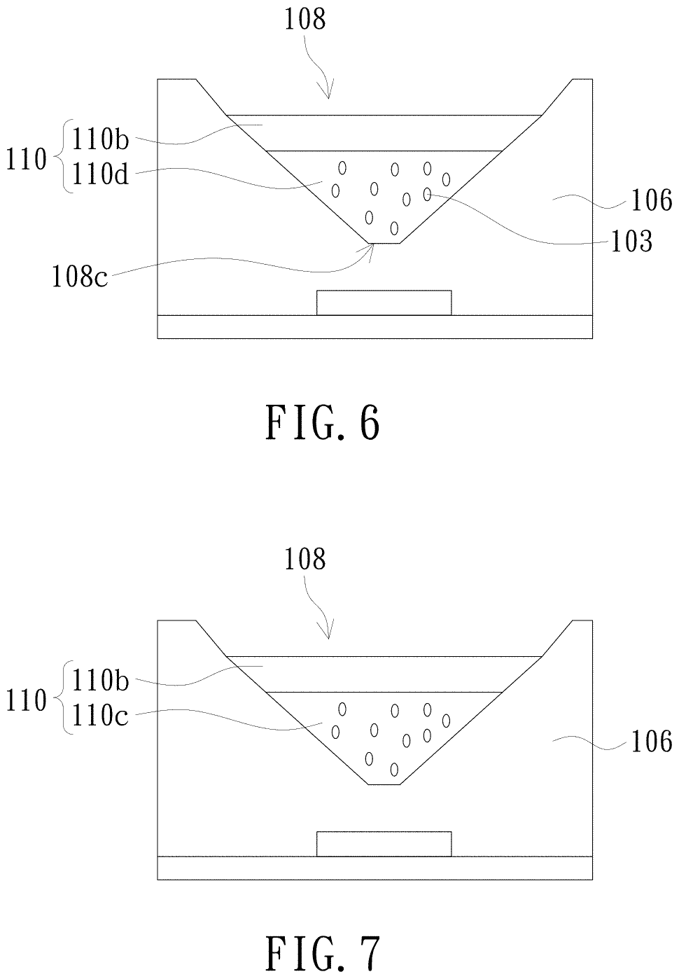

FIG. 5 is a schematic partial enlarged cross-sectional view of a light source module of one embodiment of the invention. Referring to FIG. 5, in the embodiment, the reflection pattern 110 includes a light diffusion layer 110d covering the bottom of the reflecting recess 108 and a reflective layer 110b covering the light diffusion layer 110d, wherein the refractive index of the light diffusion layer 110d is lower than the refractive index of the encapsulation layer 106. In the embodiment, the material of the reflective layer 110b may be a white lacquer having diffuse reflection properties, or a silver lacquer having specular reflection properties. In the embodiment, the bottom of the reflecting recess 108 is the bottom surface 108c, but the reflecting recess 108 whose bottom is a tip that tapers from the surrounding side surface 108a may also have the reflection pattern 110 of the embodiment. Since the refractive index of the light diffusion layer 110d is lower than the refractive index of the encapsulation layer 106, the light L1 emitted from the light emitting dies 104 is deflected when entering from the encapsulation layer 106 into the light diffusion layer 110d, thereby promoting the diffusion of the light L1. The embodiment is substantially the same as the above embodiment except that the reflection pattern 110 includes the light diffusion layer 110d and the reflective layer 110b.

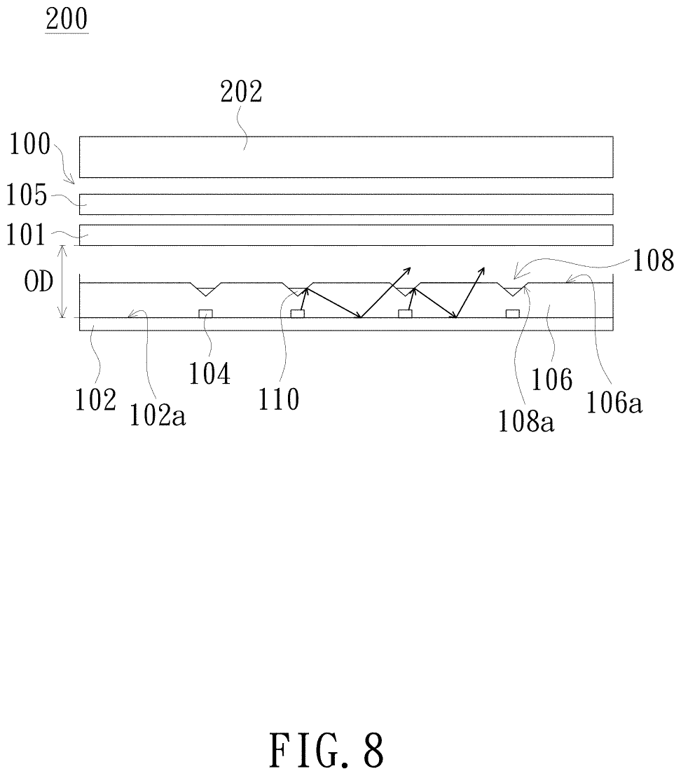

FIG. 6 is a schematic partial enlarged schematic cross-sectional view of a light source module of one embodiment of the invention. Referring to FIG. 1 and FIG. 6, in the embodiment, the reflection pattern 110 includes a light diffusion layer 110d covering the bottom of the reflecting recess 108 and a reflective layer 110b covering the light diffusion layer 110d, wherein the refractive index of the light diffusion layer 110d is lower than the refractive index of the encapsulation layer 106, and the light diffusion layer 110d includes the wavelength conversion material 103. In the embodiment, the material of the reflective layer 110b may be a white lacquer having diffuse reflection properties, or a silver lacquer having specular reflection properties. In the embodiment, the bottom of the reflecting recess 108 is the bottom surface 108c, but the reflecting recess 108 whose bottom is a tip that tapers from the surrounding side surface 108a may also have the reflection pattern 110 of the embodiment. The wavelength conversion material 103 can be a quantum dot or a phosphor. Since the light diffusion layer 110d already includes the wavelength conversion material 103, the optical structure of the light source module 100 shown in FIG. 1 to which the reflection pattern 110 of the embodiment is applied may be disposed only with the diffusion plate 101 and other optical films may be selectively disposed as needed, for example, brightness enhancement film. The embodiment is substantially the same as the above embodiment except that the light diffusion layer 110d includes the wavelength conversion material 103.

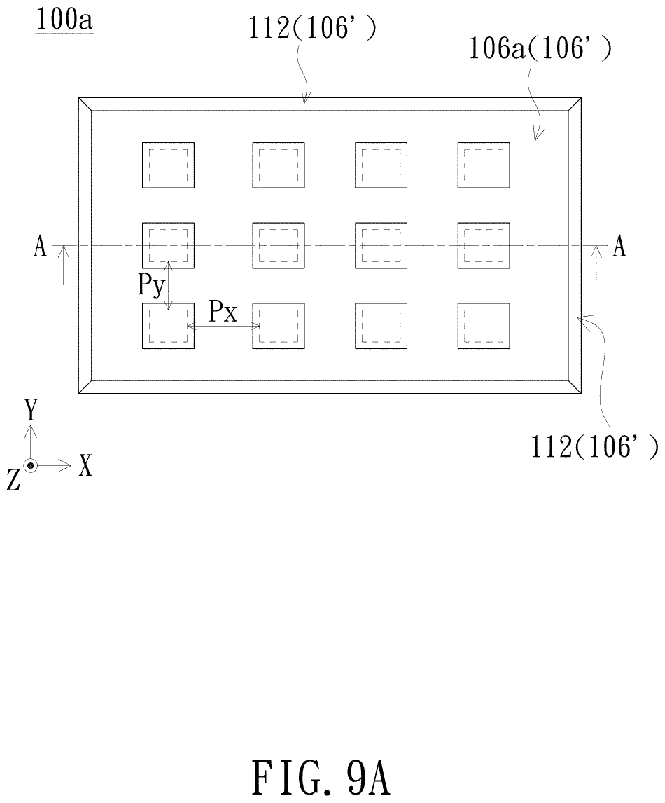

FIG. 7 is a schematic partial enlarged cross-sectional view of a light source module of one embodiment of the invention. Referring to FIG. 1 and FIG. 7, in the embodiment, the reflection pattern 110 includes a wavelength conversion layer 110c covering the bottom of the reflecting recess 108 and a reflective layer 110b covering the wavelength conversion layer 110c. The material of the wavelength conversion layer 110c may include a quantum dot or a phosphor. The embodiment is substantially the same as the embodiment of FIG. 6, except that the wavelength conversion layer 110c may not have a refractive index that lower than the encapsulation layer 106. Since the reflection pattern 110 already includes the wavelength conversion layer 110c, the optical structure of the light source module 100 shown in FIG. 1 to which the reflection pattern 110 of the embodiment is applied may be disposed only with the diffusion plate 101 and other optical films may be selectively disposed as needed, for example, brightness enhancement film.

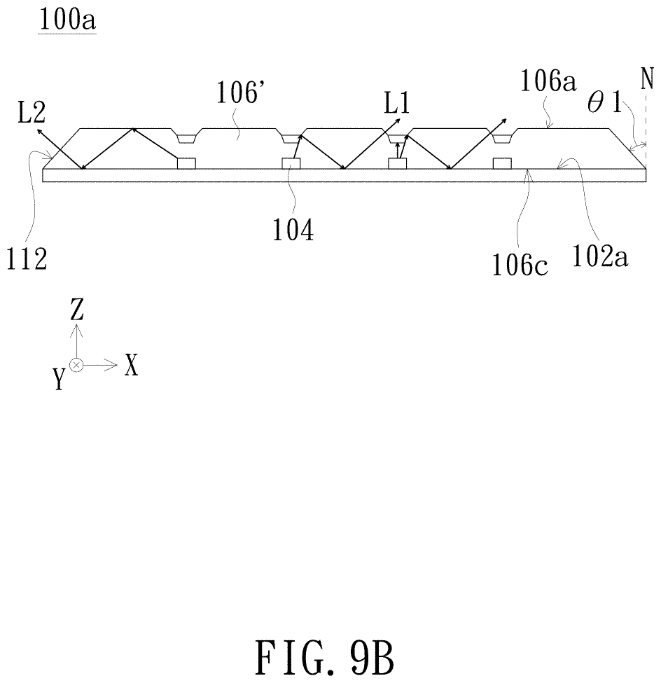

FIG. 8 is a schematic cross-sectional view of a display device of one embodiment of the invention. Referring to FIG. 8, a display device 200 of the invention includes a display panel 202 and the light source module of any of the above embodiments. In FIG. 8, the light source module 100 is taken as an example, and the optical structure included in the light source module 100 includes the diffusion plate 101 and the wavelength conversion film 105. However, when the display device of the invention includes the light source module of the different embodiments of the invention, the optical structure may be selectively disposed with the wavelength conversion film 105 or not. For example, when the display device 200 of the invention includes the light source module of the embodiment of FIGS. 4 and 5, the optical structure may include the diffusion plate 101 and the wavelength conversion film 105. On the other hand, when the display device 200 of the invention includes the light source module of the embodiment of FIGS. 6 and 7, the optical structure can omit the wavelength conversion film 105 since the reflecting recess 108 already has a material capable of wavelength conversion.

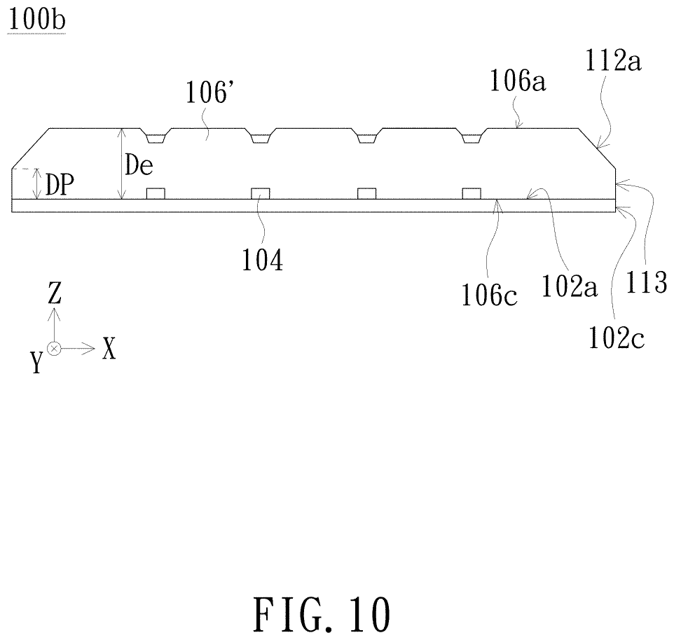

FIG. 9A is a schematic top view of a light source module of another embodiment of the invention. FIG. 9B is a schematic cross-sectional view along a line AA of FIG. 9A. Referring to FIG. 9A and FIG. 9B, the light source module 100a of the embodiment is substantially the same as the light source module 100 of FIG. 1, except that the encapsulation layer 106′ of the light source module 100a further includes at least one light guide side surface 112. The light guide side surface 112 is connected to the light emitting surface 106a and is inclined with respect to the light emitting surface 106a. The encapsulation layer 106′ is connected to the bearing surface 102a of the substrate 102 by the bottom surface 106c, and an area of the light emitting surface 106a is smaller than an area of the bottom surface 106c, so that an angle θ1 between the at least one light guide side surface 112 of the encapsulation layer 106′ and a normal N of the bearing surface 102a is less than 90 degrees. In the embodiment, the angle θ1 between the at least one light guide side surface 112 of the encapsulation layer 106′ and the normal N of the bearing surface 102a is greater than 0 degrees and less than or equal to 70 degrees.

The encapsulation layer 106′ may include a plurality of light guide side surfaces 112 surrounding the light emitting surface 106a. As shown in FIG. 9A, the encapsulation layer 106′ includes four light guide side surfaces 112, and the angle θ1 between the light guide side surfaces 112 and the normal N of the bearing surface 102a in the cross-sectional view may be identical to each other, but is not limited thereto. In other embodiments, the plurality of angles θ1 between the respective light guide side surfaces 112 of the encapsulation layer 106′ and the normal N of the bearing surface 102a may have at least two different angles. For example, when the spacing Px of the plurality of light emitting dies 104 in the X direction is different from the spacing Py of the plurality of light emitting dies 104 in the Y direction, two angles θ1 between the two light guide side surfaces 112 in the X direction (right and left side) and the normal N of the bearing surface 102a is different from two angles θ1 between the two light guide side surfaces 112 in the Y direction (up and down side) and the normal N of the bearing surface 102a. In addition, although FIG. 9A illustrates four light guide side surfaces 112, when the substrate 102 is polygonal, the encapsulation layer 106′ may also have a plurality of sides corresponding to the substrate 102, thereby including the light guide side surfaces 112 corresponding to the quantity of the plurality of sides. In other embodiments, when the substrate 102 is circular or elliptical, the encapsulation layer 106′ may also correspond to the substrate 102 that having only one light guide side surface 112 connected and surrounding the light emitting surface 106a. In the embodiment, the light guide side surface 112 is directly connected to the light emitting surface 106a and the bottom surface 106c, and is an inclined surface having a single slope, but is not limited thereto.

In the embodiment, the encapsulation layer 106′ may be first manufactured (injection moulding or pressing forming) by a mold core (not shown), and the mold core may have a structure corresponding to the reflective recess 108 (as shown in FIG. 1) and the light guide side surface 112, so that the light guide side surface 112 may have a smooth surface to facilitate the emission of a light L2.

The encapsulation layer 106′ of the light source module 100a of the embodiment of the invention has a light guiding side surface 112, and portion of the light L2 emitted by the light emitting dies 104 can be transmitted through the light guiding side surface 112 away from the bearing surface 102a and a center of the light source module 100a. When the plurality of light source modules 100a are spliced, the light L2 may be transmitted above the intervals between the light source modules 100a to produce a fill light effect.

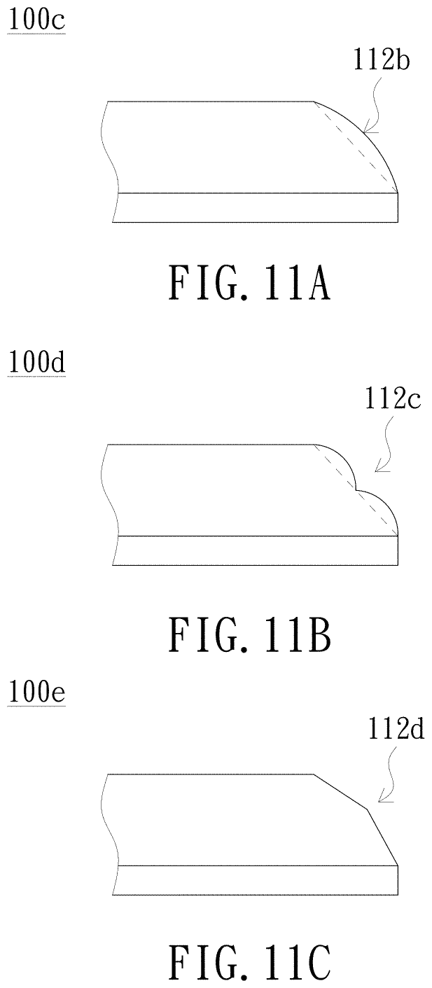

FIG. 10 is a schematic cross-sectional view of a light source module of another embodiment of the invention. Referring to FIG. 10, the light source module 100b of the embodiment is substantially the same as the light source module 100a of FIG. 9B, except that the light guide side surface 112a of the encapsulation layer 106′ of the embodiment is not directly connected to the bottom surface 106c. The substrate 102 includes at least one first side surface 102c that connects the bearing surface 102a. The encapsulation layer 106′ further includes at least one second side surface 113 connected between the at least one light guide side surface 112a and the bottom surface 106c. The at least one second side surface 113 is flush with the at least one first side surface 102c.

In the embodiment, the encapsulation layer 106′ may be first manufactured (injection moulding or pressing forming) by a mold core (not shown), and the mold core may have a structure corresponding to the reflective recess 108 (as shown in FIG. 1) and the light guide side surface 112a. When the procedure is completed, the mold core is removed, and the side residue of the substrate 102 is cut together with the excess material of the encapsulation layer 106′, and the first side surface 102c and the second side surface 113 are formed flush with each other. The second side surface 113 may be substantially perpendicular to the bearing surface 102a, but is not limited thereto. The second side surface 113 may have different inclination angles with respect to the bearing surface 102a depending on the cutting angle.

In this embodiment, a roughness of the second side surface 113 is greater than a roughness of the light guide side surface 112a. Since the second side surface 113 is formed by cutting off, it a relatively rough or atomized feature as compared to the light guide side surface 112a which is manufactured by the mold core. In the embodiment, a ratio of a height Dp of the second side surface 113 to a thickness of the encapsulation layer 106′ (a distance De between the bearing surface 102a and the light emitting surface 106a) is less than or equal to 0.1, so that the light emitted from the light source module 100b at the edge of the encapsulation layer 106′ may be mostly transmitted through the light guide side surface 112a. It is noted that the size ratio between the second side surface 113 and the encapsulation layer 106′ in FIG. 10 is not shown in accordance with the above principles in order to clearly present the second side surface 113.

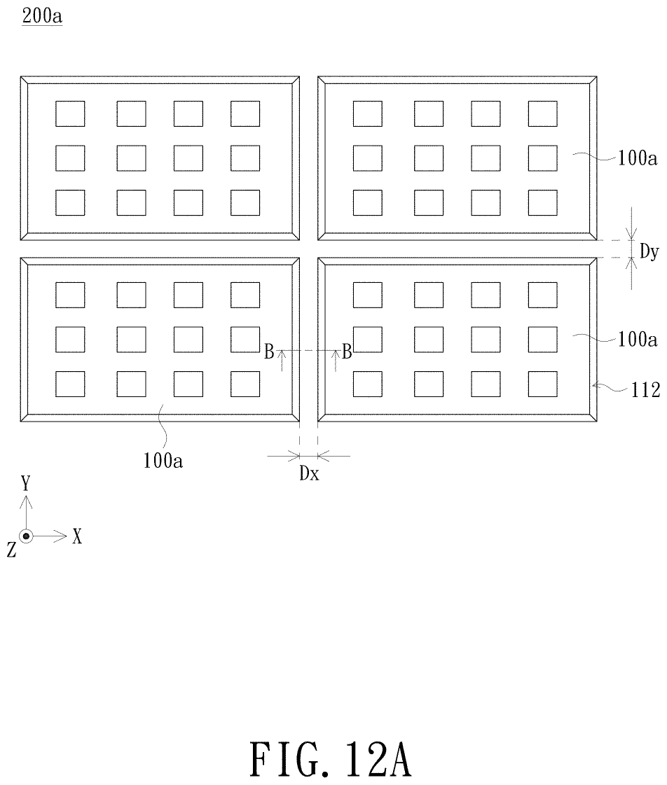

FIG. 11A to FIG. 11C are respectively schematic cross-sectional views of another embodiments of light source modules of the invention. Each of the light guide side surfaces 112 of FIG. 9B is an inclined surface having a single slope, but is not limited thereto. Referring to FIG. 11A, each of the light guiding side surfaces 112b of the light source module 100c includes a single curved surface. Referring to FIG. 11B, each of the light guiding side surfaces 112c of the light source module 100d includes a plurality of curved surfaces. Referring to FIG. 11C, each of the light guiding side surfaces 112d of the light source module 100e includes an inclined surface having a plurality of different slopes.

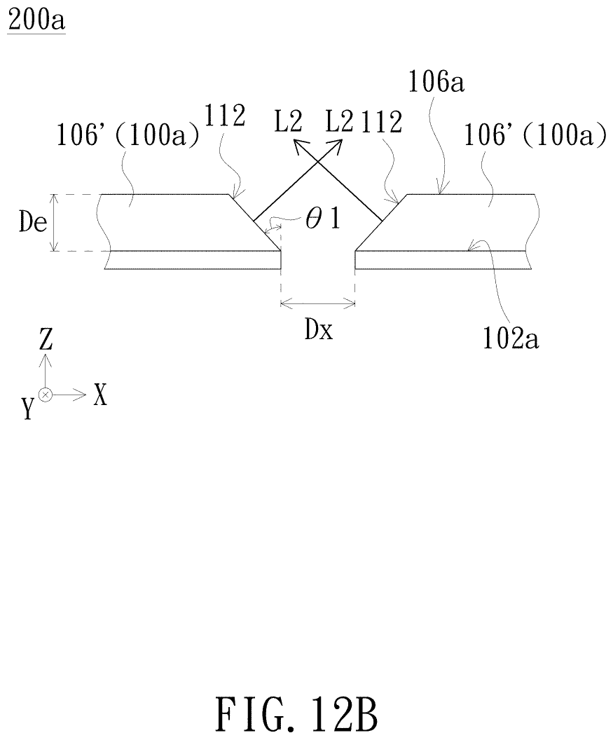

FIG. 12A is a schematic top view of splicing of a plurality of light source modules of a display device of another embodiment of the invention. FIG. 12B is a schematic cross-sectional view along a line BB of FIG. 12A. Referring to FIG. 12A and FIG. 12B, the display device 200a of the embodiment is substantially the same as the display device 200 of FIG. 8, except that the display device 200a has a plurality of light source modules arranged at an interval from each other. The light source modules may be the light source modules of any of the above embodiments, and may also include the light source modules of other different embodiments. The embodiment is described by taking the light source module 100a of FIG. 9B as an example. Since each of the light source modules 100a can emit light L2 from the light guide side surface 112 of the encapsulation layer 106′, the light L2 of the two adjacent light source modules 100a can be mixed above the intervals between the plurality of light source modules 100a, for example, an interval Dx in the X direction and an interval Dy in the Y direction in FIG. 12A, to fill light to an area above the interval Dx and the interval Dy.

The ratio of the interval between the plurality of light source modules 100a, for example, the interval Dx in the X direction, to a thickness of the encapsulation layer 106′ of each of the light source modules 100b (a distance De between the bearing surface 102a and the light emitting surface 106a) may be less than or equal to 2. For example, the interval Dx is less than or equal to 2 mm, and the distance De is less than or equal to 1 mm, but is not limited thereto. The interval Dy may be the same as the interval Dx, but is not limited thereto. If the required filling light levels in the X direction and the Y direction are different, the interval Dy may be different from the interval Dx.

When the angle θ1 between the light guide side surface 112 of the encapsulation layer 106′ of each of the light source modules 100a and the normal N of the bearing surface 102a is greater than 0 degrees and less than or equal to 70 degrees, and the interval between the plurality of light source modules 100a is appropriately adjusted, for example, the ratio of the interval Dx (or the interval Dy) to the distance De is less than or equal to 2, the light L2 of any two adjacent light source modules 100a can be fully mixed above the interval Dx and the interval Dy, and the surface light source composed of the light source modules 100a does not have obvious dark lines or bright lines at the interval Dx and the interval Dy, thereby having good uniformity.

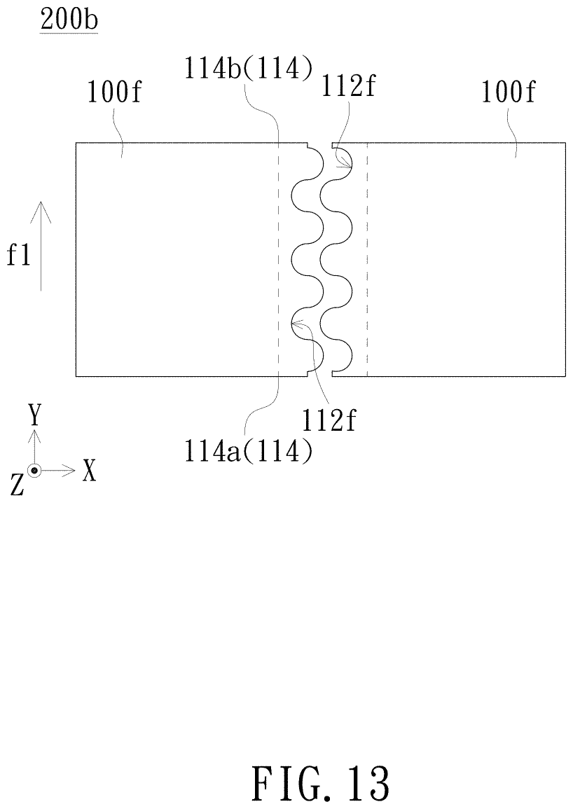

FIG. 13 is a schematic view of splicing of a plurality of light source modules of a display device of another embodiment of the invention. Referring to FIG. 13, the display device 200b of the embodiment is substantially similar to the display device 200a of FIG. 12A, except for the shape of the light guide side surface 112f.

In the embodiment, each of the light guide side surfaces 112f is connected to a side end 114 of the corresponding light emitting surface 106a. The side end 114 has a first end 114a and a second end 114b, and each of the light guide side surfaces 112f has a continuous concave-convex structure along a predetermined direction f1 from the first end 114a to the second end 114b. The predetermined direction f1 may be, for example, parallel to the Y direction. The concave-convex structure of each of the light guide side surfaces 112f is complementary to another concave-convex structure of the light guide side surfaces 112f of the adjacent light source module 100f to further enhance the effect of light mixing.

It is noted that the concave-convex structure of the light guide side surface 112f is not limited to the form illustrated in FIG. 13, but may include any concave-convex structure that is complementary to another concave-convex structure.

The display device of the invention has a light source module able to provide a uniform light source. When the control module is used, the light source module of the embodiment of the invention may further have a local dimming function, so that the display device of the invention becomes a device able to provide high resolution and high contrast.

In addition, in order to improve the uniformity of the surface light source of the display device having a plurality of light source modules spliced together, the encapsulation layer of the light source module of the embodiment of the invention has a light guide side surface, and the display device of the embodiment of the invention has a plurality of light source modules arranged at intervals.

In the technical field of display device, a method to provide a surface light source for a large-sized display device often employs a plurality of light source modules spliced with each other. However, the horizontally intervals are often generated between the spliced light source modules due to the dimensional tolerances of the substrate and the cutting tolerances after the encapsulation, and the substrate is warped after being encapsulated at a high temperature, so that the adjacent two light source modules also have a height difference in the vertical direction. In addition, the side surfaces of the cut encapsulation layer are mostly rough or atomized surfaces, which also cause discontinuous light transmission between two adjacent light source modules. The above problem causes the surface light source composed of the splicing of the plurality of light source modules to have obvious bright lines or dark lines, thereby does not have sufficient uniformity.

The encapsulation layer of the light source module of the embodiment of the invention has a light guiding side surface, and portion of the light emitted by the light emitting dies can be transmitted through the light guiding side surface away from the bearing surface and a center of the light source module. The display device of the invention has a plurality of light source modules arranged at intervals, and the light from different light source modules can be mixed above the intervals between the light source modules to avoid the appearance of obvious dark lines or bright lines above the intervals of the surface light source formed by the light source modules, thereby having good uniformity.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first side surface, the second side surface, the first end and the second end are only used for distinguishing various elements and do not limit the number of the elements.

What is claimed is:

1. A light source module, comprising a substrate, a plurality of light emitting dies, an encapsulation layer, and a plurality of reflection patterns, wherein:
the substrate has a bearing surface;
the plurality of light emitting dies is disposed on the bearing surface of the substrate;
the encapsulation layer covers the bearing surface and the plurality of light emitting dies, the encapsulation layer comprises a light emitting surface away from the bearing surface and a bottom surface connected to the bearing surface, an area of the light emitting surface is smaller than an area of the bottom surface, the light emitting surface has a plurality of reflecting recesses respectively disposed corresponding to the plurality of light emitting dies, the plurality of reflecting recesses respectively comprises a surrounding side surface inclined with respect to the light emitting surface, and the encapsulation layer further comprises at least one light guide side surface connected to the light emitting surface and inclined with respect to the light emitting surface; and
the plurality of reflection patterns is respectively disposed in the plurality of reflecting recesses.

2. The light source module according to claim 1, wherein an angle between the at least one light guide side surface of the encapsulation layer and a normal of the bearing surface is greater than 0 degrees and less than or equal to 70 degrees.

3. The light source module according to claim 2, wherein the at least one light guide side surface is a plurality of light guide side surfaces, and a plurality of angles between the plurality of light guide side surfaces and the bearing surface respectively has at least two different angles.

4. The light source module according to claim 1, wherein the at least one light guide side surface comprises a single curved surface, a plurality of curved surfaces, an inclined surface having a single slope or an inclined surface having a plurality of different slopes.

5. The light source module according to claim 1, wherein the substrate comprises at least one first side surface connected to the bearing surface, the encapsulation layer further comprises at least one second side surface connected between the at least one light guide side surface and the bottom surface, and the at least one second side surface is flush with the at least one first side surface.

6. The light source module according to claim 1, wherein the encapsulation layer further comprises at least one second side surface connected between the at least one light guide side surface and the bottom surface, and the at least one second side surface is substantially perpendicular to the bearing surface.

7. The light source module according to claim 5, wherein a roughness of the at least one second side surface is greater than a roughness of the at least one light guide side surface.

8. The light source module according to claim 5, wherein a ratio of a height of the second side surface to a thickness of the encapsulation layer is less than or equal to 0.1.

9. The light source module according to claim 1, wherein each of the plurality of light guide side surfaces is connected to a side end of the corresponding light emitting surface, the side end has a first end and a second end, and each of the plurality of light guide side surfaces has a continuous concave-convex structure along a predetermined direction from the first end to the second end.

10. The light source module according to claim 1, wherein each of the reflecting recesses has an opening on the light emitting surface, each of the light emitting dies comprises a light emitting surface facing the opening, and an area of the opening is larger than an area of the light emitting surface.

11. The light source module according to claim 10, wherein in a cross-sectional view passing through a center of a pair of corresponding light emitting dies and a center of the reflecting recess and perpendicular to the light emitting surface, a distance between two ends of the opening is D, a distance between two ends of the light emitting surface is L, a distance between the light emitting surface and the bearing surface is Dl, a distance between the bearing surface and the light emitting surface is De, a depth of the reflecting recess is H, and H<De-Dl, a refractive index of the encapsulation layer is Nm, a refractive index of air is Na, a total reflection critical angle of a light beam emitted from one end of the light emitting surface toward the light emitting surface is θ, and θ=sin⁻¹ (Na/Nm), the distance D between the two ends of the opening satisfies a relationship: D≥2×[(De-Dl)×tan (sin⁻¹ (Na/Nm))+L/2].

12. The light source module according to claim 1, wherein each of the reflection patterns comprises a reflective layer covering a bottom of the reflecting recess.

13. The light source module according to claim 1, wherein each of the reflection patterns comprises a light diffusion layer and a reflective layer, wherein:
the light diffusion layer covers a bottom of the reflecting recess, and a refractive index of the light diffusion layer is lower than a refractive index of the encapsulation layer; and
the reflective layer covers the light diffusion layer.

14. The light source module according to claim 13, wherein the light diffusion layer comprises a wavelength conversion material.

15. The light source module according to claim 1, wherein each of the reflection patterns comprises a wavelength conversion layer and a reflective layer, wherein:
the wavelength conversion layer covers a bottom of the reflecting recess; and
the reflective layer covers the wavelength conversion layer.

16. The light source module according to claim 1, wherein in each of the reflecting recesses, the reflection pattern has a top surface away from a bottom of the reflecting recess, and a distance from the top surface to the bottom is smaller than a depth of the reflecting recess.

17. The light source module according to claim 1, wherein a bottom of the reflecting recess is a tip that tapers from the surrounding side surface.

18. The light source module according to claim 1, wherein the surrounding side surface is an inclined surface having a single slope or an inclined surface comprising a plurality of different slopes.

19. The light source module according to claim 1, further comprising a diffusion plate and a wavelength conversion film, wherein:
the diffusion plate is disposed above the encapsulation layer; and
the wavelength conversion film is disposed between the encapsulation layer and the diffusion plate or disposed above the diffusion plate.

20. A display device, comprising a plurality of light source modules and a display panel, wherein:
the plurality of light source modules are arranged at intervals with each other, each of the plurality of light source modules comprises a substrate, a plurality of light emitting dies, an encapsulation layer and a plurality of reflection patterns, wherein:
the substrate has a bearing surface;
the plurality of light emitting dies is disposed on the bearing surface of the substrate;
the encapsulation layer covers the bearing surface and the plurality of light emitting dies, the encapsulation layer comprises a light emitting surface away from the bearing surface and a bottom surface connected to the bearing surface, an area of the light emitting surface is smaller than an area of the bottom surface, the light emitting surface has a plurality of reflecting recesses respectively disposed corresponding to the plurality of light emitting dies, the plurality of reflecting recesses respectively comprises a surrounding side surface inclined with respect to the light emitting surface, and the encapsulation layer further comprises at least one light guide side surface connected to the light emitting surface and inclined with respect to the light emitting surface;
the plurality of reflection patterns is respectively disposed in the plurality of reflecting recesses; and
the display panel is disposed relative to the plurality of light source modules and is adjacent to the light emitting surface.

21. The display device according to claim 20, wherein an angle between each of the plurality of light guide side surfaces of the encapsulation layer and a normal of the bearing surface is greater than 0 degrees and less than or equal to 70 degrees, a ratio of an interval between each of the plurality of light source modules to a thickness of an encapsulation layer of each of the plurality of light source modules is less than or equal to 2.

22. The display device according to claim 21, wherein the interval between each of the plurality of light source modules is less than or equal to 2 mm, and the thickness of the encapsulation layer of each of the plurality of light source modules is less than or equal to 1 mm.

23. The display device according to claim 20, wherein each of the plurality of light guide side surfaces is connected to a side end of the corresponding light emitting surface, the side end has a first end and a second end, and each of the plurality of light guide side surfaces has a continuous concave-convex structure along a predetermined direction from the first end to the second end, the concave-convex structure of each of the plurality of light guide side surfaces is complementary to another concave-convex structure of the light guide side surfaces of the adjacent light source module.
